(19) United States
(12) Patent Application Publication
(10) Pub. No.: US 2016/0069666 A1
(43) Pub. Date: Mar. 10, 2016

(54) HEIGHT MEASURE METHOD AND ELECTRONIC DEVICE USING SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventor: YU ZHANG, Shenzhen (CN)

(21) Appl. No.: 14/682,746

(22) Filed: Apr. 9, 2015

(30) Foreign Application Priority Data
Sep. 4, 2014 (CN) 201410448315.2

(51) Int. Cl. G01B 11/02; G01B 11/26

(52) U.S. Cl. CPC G01B 11/02; G01B 11/26

(57) ABSTRACT

A height measurement method is provided. The method includes: detecting, at a sensor of an electronic device, a distance between the electronic device and an object to be measured; emitting, from two apertures of the sensor, two beams of light, wherein one of the beams is directed at a first end of the object to form a first light spot at the first end of the object and the other one of the beams is directed at a second end of the object to form a second light spot at the second end of the object; obtaining, at the electronic device, a first angle between one of the beams and a horizontal line and a second angle between the other one of the beams and the horizontal line; and calculating, at the electronic device, a height of the object based on the first and second angles and the distance.

### FIELD

The subject matter herein generally relates to a height measurement method and an electronic device using same.

### BACKGROUND

Traditional measurement devices, for example, rulers, tapes or gauges, are widely used to measure a length, a width, a height, or a depth of an object to be measured. In general, it is necessary to put such traditional measurement devices close to the object to be measured. However, some objects to be measured are hard to be reached. Therefore, there is a need for a measuring device for measuring the objects that are hard to be reached.

### BRIEF DESCRIPTION OF THE DRAWINGS

Implementations of the present technology will now be described, by way of example only, with reference to the attached figures.

FIG. 1 is a diagrammatic view of an exemplary embodiment of an electronic device.

FIG. 2 is a flowchart of an exemplary embodiment of a height measurement method.

FIG. 3 is a diagram of an exemplary embodiment of calculating a height of an object to be measured.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

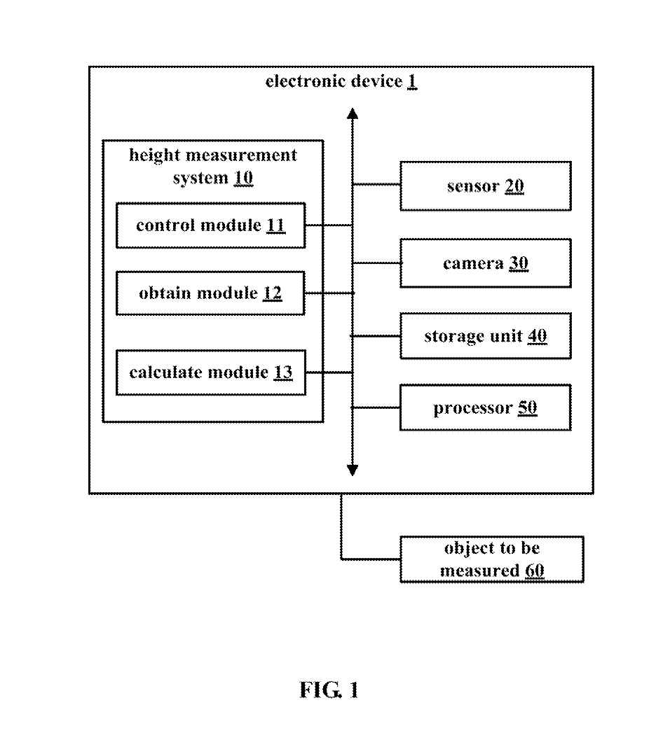

FIG. 1 illustrates a diagrammatic view of an exemplary embodiment of an electronic device 1. In the example embodiment, the electronic device 1 can be a smart phone, a pad or other handheld device. The electronic device can include, but not limited to, a sensor 20, a camera 30, a storage unit 40, and a processor 50. The sensor 20 can be a distance sensor and can be configured to detect a distance between the electronic device 1 and an object 60 to be measured. The sensor 20 can include a plurality of apertures, and further can be configured to emit a plurality of beams of light from the apertures to form a plurality of light spots onto the object 60. The camera 30 can be configured to provide a preview window to observe where the beams of light spots formed on the object 60.

The storage unit 40 can be an internal storage unit of the electronic device 1, for example, a hard disk or memory, or a pluggable memory, for example, Smart Media Card, Secure Digital Card, Flash Card. In at least one embodiment, the storage unit 40 can include two or more storage devices such that one storage device is an internal storage unit and the other storage device is a pluggable memory. The storage unit 40 can be configured to store a plurality of angles each corresponding to an aperture of the sensor 20. Each angle indicates an angle between a horizontal line and a beam of light emitted from one of the plurality of apertures.

The processor 50 can be a central processing unit (CPU), a microprocessor, or other data processor chip that performs functions of the electronic device 1.

A height measurement system 10 can include computerized instructions in the form of one or more programs that can be stored in the storage unit 40 and executed by the processor 50. In the embodiment, the height measurement system 10 can be integrated in the processor 50. In at least one embodiment, the height measurement system 10 can be independent from the processor 50 and coupled to the processor 50. The system 10 can include one or more modules, for example, a control module 11, an obtain module 12, and a calculate module 13. A “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The control module 11 can be configured to control the sensor to detect the distance between the electronic device and the object, and to emit beams of light onto the object. The obtain module 12 can be configured to obtain the distance between the electronic device and the object from the sensor. The obtain module 12 further can be configured to obtain two angles between the horizontal line and two beams of light emitting respectively onto the two ends of the object. The calculate module 13 can be configured to calculate the height of the object based on the two angels and the distance between the electronic device and the object.

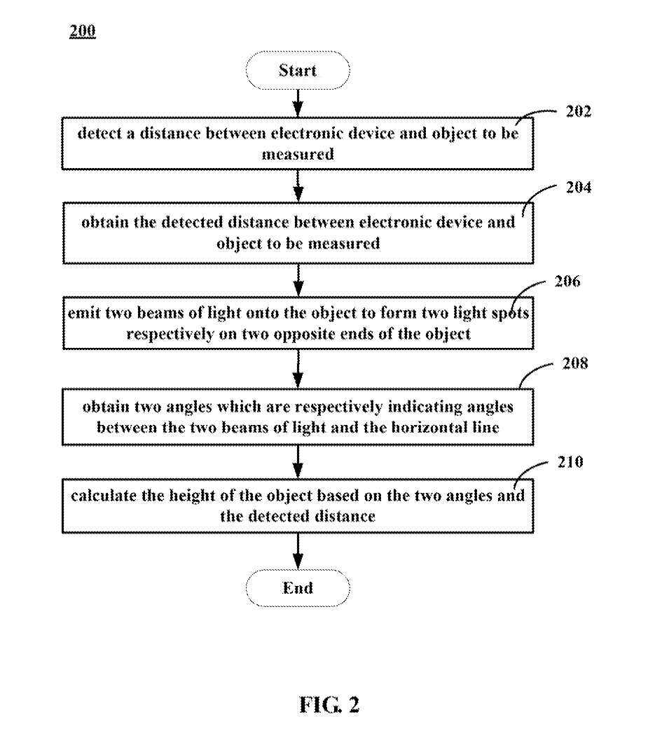

Referring to FIG. 2, a flowchart is presented in accordance with an example embodiment which is being thus illustrated. The example method 200 is provided by way of example, as there are a variety of ways to carry out the method. The method 200 described below can be carried out using the configurations illustrated in FIG. 1, for example, and various elements of these figures are referenced in explaining example method 200. Each block shown in FIG. 2 represents one or more processes, methods or subroutines, carried out in the exemplary method 200. Furthermore, the illustrated order of blocks is by example only and the order of the blocks can change according to the present disclosure. Additional blocks may be added or fewer blocks may be utilized, without departing from this disclosure. The exemplary method 200 for measuring a height of an object is illustrated in FIG. 2. The exemplary method 200 can be executed by an electronic device, and begin at block 202. The electronic device can include a distance sensor, a camera, and a storage unit. The distance sensor can be configured to detect a distance between the electronic device and the object to be measured. The distance sensor further can be configured to emit a plurality of beams of light from a plurality of apertures of the distance sensor. The storage unit can be configured to store a plurality of angles each indicating an angle between a horizontal line and a beam of light emitted from one of the plurality of apertures. The camera can be configured to provide a preview window.

At block 202, the electronic device controls the distance sensor to detect a distance between the electronic device and the object to be measured.

At block 204, the electronic device obtains the distance detected by the distance sensor.

At block 206, the electronic device controls the distance sensor to emit two beams of light from two of the plurality of apertures onto the object to form two light spots respectively on two opposite ends of the object. In detail, the light spots can be observed by a user through a preview window of the camera. If the light spots do not reach the two ends of the object, the electronic device can control the distance sensor to switch to other apertures to emit the beams of light until the light spots exactly reach the two ends of the object.

At block 208, the electronic device obtains a first angle between one of the beams and a horizontal line and a second angle between the other one of the beams and the horizontal line. In detail, the electronic device searches the storage unit by the two apertures from which the two beams of light are emitted to obtain the first and the second angles.

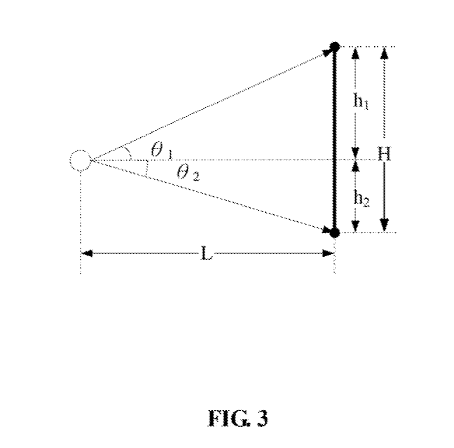

At block 210, the electronic device calculates the height of the object based on the first and second angles and the distance between the electronic device and the object. For example, an example of calculating the height of the object is illustrated in FIG. 3. The height H can be calculated by a formula: H=h1+h2=L*Tan θ₁+L*Tan θ₂=L*(Tan θ₁+Tan θ₂), wherein H represents a height of the object; L represents a distance between the electronic device and the object; θ₁ represents the first angle and θ₂ represents the second angle.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A height measurement method, comprising:
detecting, at a sensor of an electronic device, a distance between the electronic device and an object to be measured;
emitting, from two apertures of the sensor of the electronic device, two beams of light, wherein one of the beams is directed at a first end of the object to form a first light spot at the first end of the object and the other one of the beams is directed at a second end of the object to form a second light spot at the second end of the object;
obtaining, at the electronic device, a first angle between one of the beams and a horizontal line and a second angle between the other one of the beams and the horizontal line; and
calculating, at the electronic device, a height of the object based on the first and second angles and the distance between the electronic device and the object.

2. The method according to claim 1, wherein emitting the two beams of light onto the object comprises:
displaying, at the electronic device, an image of the object and the first and two light spots, wherein when the two beams of light are respectively directed at the first and second ends, the first and second light spots respectively reach the first and second ends;
determining, at the electronic device, whether the two beams of light are respectively directed at the first and second ends by observing the image of the object and the first and second light spots;
switching, at the electronic device, to another two apertures from which two beams of light are emitted until the first and second light spots respectively reach the first and second ends.

3. The method according to claim 1, further comprising: storing, at the electronic device, a relationship between apertures of the sensor from which the two beams of light are emitted and the first and second angles.

4. The method according to claim 1, wherein the height of the object is calculated based on a formula: H=L*(Tan θ₁+Tan θ₂), wherein H is height of the object, θ₁ and θ₂ represent respectively the first and second angles.

5. An electronic device, comprising:
a sensor configured to detect a distance between the electronic device and an object to be measured, wherein the sensor comprising a plurality of apertures from which a plurality of beams of light can be emitted;
a storage unit configured to store instructions;
a processor configured to execute the instructions to cause the processor to:
control the sensor to detect the distance between the electronic device and the object to be measured;
control the sensor to emit two beams of light from two of the plurality of apertures, wherein the two beams of light reach two opposite ends of the object along a direction of a height of the object, wherein one of the beams is directed at a first end of the object to form a first light spot at the first end of the object and the other one of the beams is directed at a second end of the object to form a second light spot at the second end of the object;
obtain a first angle between one of the beams and a horizontal line and a second angle between the other one of the beams and the horizontal line; and
calculate a height of the object based on the first and second angles and the distance between the electronic device and the object.

6. The electronic device according to claim 5, wherein the storage unit further configured to store a relationship between apertures of the sensor from which the two beams of light are emitted and the first and second angles.

7. The electronic device according to claim 5, further comprising a camera configured to provide a preview window from which an image of the object and the first and second light spots can be observed for determining whether the two beams of light are exactly directed at the first and second end.

8. The electronic device according to claim 5, wherein the height of the object is calculated based on a formula: H=L*(Tan θ₁+Tan θ₂), wherein H is height of the object, θ₁ and θ₂ represent respectively the first and second angles.
